(19) United States
(12) Patent Application Publication
(10) Pub. No.: US 2013/0252692 A1
(43) Pub. Date: Sep. 26, 2013

(54) METHOD FOR CONTROLLING A GAMBLING OR ENTERTAINMENT MACHINE AND GAMBLING OR ENTERTAINMENT MACHINE

(71) Applicant: GAMOMAT GMBH, Wagenfeld (DE)

(72) Inventor: Dietmar Hermjohannes, Wagenfeld (DE)

(73) Assignee: GAMOMAT GmbH, Wagenfeld (DE)

(21) Appl. No.: 13/847,854

(22) Filed: Mar. 20, 2013

(30) Foreign Application Priority Data
Mar. 20, 2012 (DE) 10 2012 005 592.7
Mar. 20, 2012 (DE) 10 2012 005 714.8

(51) Int. Cl. G07F 17/34

(52) U.S. Cl. CPC G07F 17/34
USPC 463/17

(57) ABSTRACT

The invention relates to a method for controlling a gambling or entertainment machine, which includes at least one central control unit, at least one display means including symbols (reels or disks or screen), keys actuatable by the player to influence the course of the game, memories with associated displays for credits and/or winnings as well as event-dependent memories. The at least one display means including symbols with various win symbols and at least one loss symbol is actuated by the central control unit and stopped at random positions. Subsequently, at least one win symbol indicated in the stop position of the display means including symbols is counted in a memory associated to the win symbol, wherein win values are associated to the respective count value. Down to a specified lower count value limit, the win value can be zero and become greater than zero only after exceedance of this lower count value limit. When the loss symbol is represented in the stop position of the display means including symbols, at least one of the memories associated to the win symbols is reset.

### CROSS-REFERENCE TO RELATED APPLICATIONS

This application claims the benefit of the German Patent Application No. 10 2012 005 714.8 filed Mar. 20, 2012 and of the German Patent Application No. 10 2012 005 592.7 filed Mar. 20, 2012, the disclosures of which are fully incorporated herein by reference.

### BACKGROUND

The present invention relates to a method for controlling a gambling or entertainment machine, which includes at least one central control unit, at least one display means including symbols (reels or disks or screen), keys actuatable by the player to influence the course of the game, memories with associated displays for credits and/or winnings as well as event-dependent memories.

The structure and basic mode of operation of gambling machines as described above have long since been known already. Usually, the same are put into operation by putting in coins. As game result, there can either be achieved a winning combination of symbols, so that the credit memory, which can include credits in the form of points or amounts of money, is at least incremented by this winning amount. Alternatively, the game result can consist in that a non-winning combination of symbols does not lead to a win. In this case, the credit memory (money or points) merely is reduced by the bets to be paid. In the case of winning symbol combinations as outcome of a game it is furthermore known to subsequently further increase this amount won here via a risk gambling device or possibly also lose the same again.

For all these gaming operations the limit values prescribed on the part of the legislator as regards the maximum win or loss per hour must be maintained. Essential win parameters already are limited thereby, so that the entire course of the game can only be varied to a greatly limited extent.

### BRIEF SUMMARY OF THE INVENTION

Aspects of the present invention propose a method for controlling gambling or entertainment machines, which by maintaining the legal limit values provides for a more variable design of the gaming and winning behavior.

As compared to the prior art, aspects of the present invention is characterized in that the at least one display means including symbols with various win symbols and at least one loss symbol is actuated by the central control unit and stopped at random positions. Subsequently, a win symbol indicated in the stop position of the at least one display means including symbols is each counted in a memory associated to this win symbol, wherein win values are associated to the respective count value. Down to a specified lower count value limit, the win value can be zero and can become greater than zero only after exceedance of this lower count value limit. When the loss symbol is represented in the stop position of the display means, at least one of the memories associated to the win symbols is reset.

In the case of several, i.e. at least two display means each with different win symbols and at least one loss symbol, several (different) win symbols can be indicated in a stop position. Correspondingly, the win symbols indicated in the stop position of the display means including symbols here are each counted in the memory associated to the respective win symbols.

According to a first possible aspect of the solution according to the invention it can be provided that when the loss symbol is represented in the stop position of at least one display means including symbols, all memories associated to the win symbols are reset.

According to a second possible aspect of the solution according to the invention it can be provided that when the loss symbol is represented in the stop position of the at least one display means including symbols several memories—possibly to be selected by a user—are reset, wherein each reset memory is associated to another one of the win symbols indicated as game result. In such a design variant, not all of the event-dependent memories hence are reset when at least one loss symbol is represented, but only a part of the memories and in a possible development even only a part of the memories selectable by a user.

According to further possible aspects it can be provided that when the loss symbol is represented in the stop position of the at least one display means, the memory with the highest count value associated to the win symbols is reset.

Furthermore, it can be provided that when the loss symbol is represented in the stop position of the at least one display means, at least one memory associated to the win symbols is randomly selected and reset via the central control unit.

In addition, it can be provided that when the loss symbol is represented in the stop position of the at least one display means, a memory associated to the win symbols is selected and reset in a player-controlled manner via the keys actuatable by the player to influence the course of the game. In other words, when in this design variant a loss symbol is represented in the stop position of the at least one display means, a user can select a memory associated to the win symbols via the keys actuatable by the player to influence the course of the game, so that then (only) the one selected memory is reset. In a possible development it can be provided that when a loss symbol is represented in the stop position of the at least one display means including symbols, a user can select several memories for one win symbol each and then the selected memories are reset.

A further possible aspect of the solution according to the invention consists in that from a specified count value upper limit of at least one of the memories associated to the win symbols resetting the same is effected to a value greater than zero, when the loss symbol is represented in the stop position of the display means including symbols. When the loss symbol is represented in the stop position of the at least one display means, resetting of the memory thus is effected to a value greater than zero, in which a count value upper limit has been exceeded, or resetting of another memory.

A further aspect of the present invention is a gambling or entertainment machine, which includes at least one central control unit, at least one display means including symbols, keys actuatable by the player to influence the course of the game, memories with associated displays for credits and/or winnings as well as event-dependent memories, wherein the at least one display means includes various win symbols and at least one loss symbol, and the central control unit is formed and provided to
actuate the at least one display means including the symbols and stop the same at random positions,
count win symbols indicated in the stop position of the at least one display means including symbols each in a memory associated to the win symbol, wherein win values are associated to the respective count value, and
when the loss symbol is represented in the stop position of the at least one display means including symbols, reset at least one of the memories associated to the win symbols.

A gambling or entertainment machine according to the invention thus is controllable in particular by a method according to the invention, so that in connection with design variants for a method according to the invention the advantages and features described above and below also are applicable for a gambling or entertainment machine according to the invention, and vice versa.

### BRIEF DESCRIPTION OF THE DRAWINGS

The solution according to the invention will be explained in detail below with reference to the illustration of exemplary embodiments.

FIG. 1 shows a first gambling or entertainment machine formed according to the invention, which among other things includes a random controlled symbol display as display means, which is formed as rotating reel.

FIG. 2A shows an enlarged representation of the symbol display of FIG. 1 with an indicated win symbol.

FIG. 2B shows an enlarged representation of the symbol display of FIG. 1 with an indicated loss symbol.

FIG. 3A shows a flow diagram for an operation of a gambling or entertainment machine, which is controlled with a method according to the invention.

FIG. 3B shows a further flow diagram for an operation of a gambling or entertainment machine, which is controlled with a variant of a method according to the invention.

FIG. 4 shows a second gambling or entertainment machine formed according to the invention, which among other things includes three random controlled symbol displays as display means, which each are formed as rotating reels.

FIG. 5A shows an enlarged representation of the symbol displays of FIG. 4 each with an indicated win symbol.

FIG. 5B shows an enlarged representation of the symbol displays of FIG. 4 with an indicated loss symbol.

### DETAILED DESCRIPTION

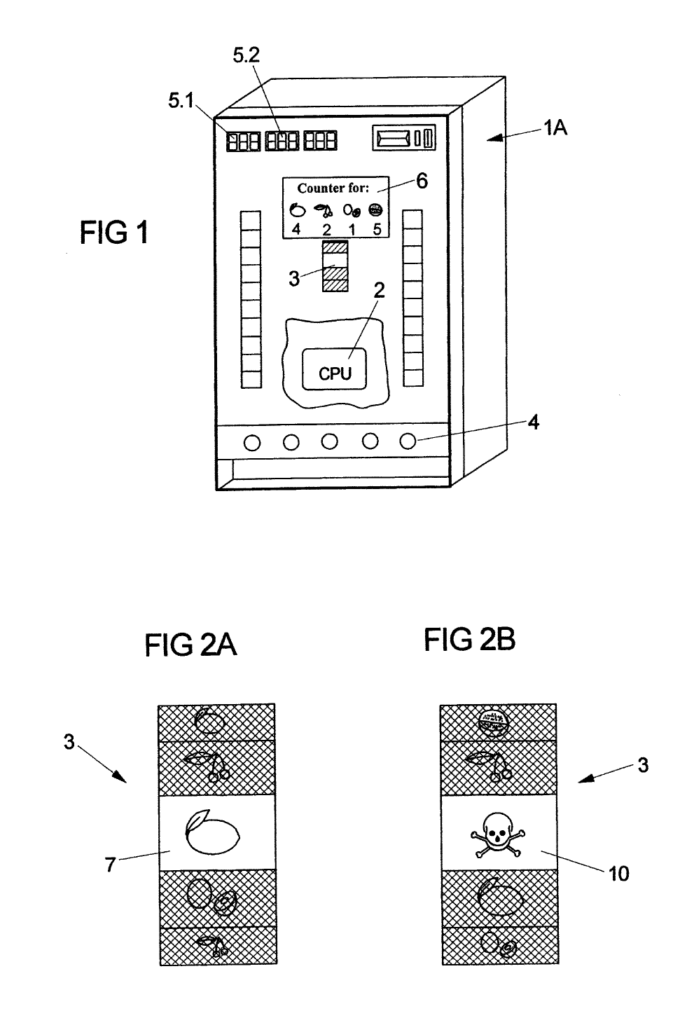

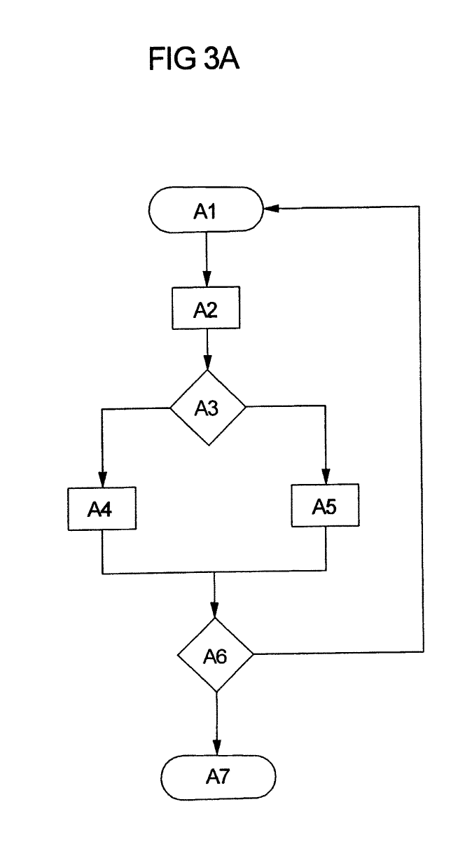

FIG. 1 initially shows a gambling or entertainment machine 1A formed according to the invention, which includes a central control unit 2, a random controlled symbol display 3 formed as rotating reel for representing game results (shown in part and on an enlarged scale in FIGS. 2A and 2B) as well as keys 4 for influencing the course of the game.

In the method according to the invention, a game initially is started by decrementing the required bets of one of the credit memories (point or cash balance) 5.1, 5.2. The display means 3 including symbols is set in motion and subsequently stopped at a randomly selected position.

In the result of this game, the random controlled display means 3 shows a win symbol 7 in a window according to FIG. 2A, which here consists of a lemon symbol by way of example. This game result leads to the fact that the memory 6 associated to the lemon symbol is incremented by one count and this is indicated correspondingly. The same procedure applies when for example the cherry symbol or the kiwi symbol appears as game result. In this case, the memory associated to the cherry symbol or the kiwi symbol would be incremented.

In a game or win plan not shown in detail, the player is informed which win value is associated to the respectively indicated count value of the individual win symbols 7. For example, the count value “4” for the lemon symbol might symbolize a win value of 80 points, the count value “2” for the cherry symbol and the count value “1” for the kiwi symbol might symbolize a win value of 0 points, and the count value “5” for the melon symbol might symbolize a win value of 250 points.

By actuating one of the keys 4 for influencing the course of the game, the player might accept the associated win values, whereby the associated win memory 5.1 or 5.2 is incremented by the sum of the win values. At the same time, the memories 6 associated to the win symbols 7 would be reset.

When the game is continued without accepting this win, it is possible that as next game result a loss symbol 10 is displayed in the window shown in FIG. 2B in the case of the random stop of the display means 3 including symbols. In this case, it can be provided that for example all indicated count values of the win symbols 7, which are stored in the event-dependent memory 6, are reset to zero. Thus, this would correspond to a total loss of the win values achieved so far.

Alternatively, it can be provided for example that only the greatest count value stored and indicated—i.e. in the illustrated case the count value “5” for the melon symbol—is reset to zero or a lower count value. In this case, the appearance of the loss symbol 10 would not mean a total loss of win values achieved so far, but only a partial loss.

Furthermore, it is possible that upon appearance of the loss symbol 10 one of the memories 6 for the win values of the win symbols counted so far is randomly selected via the central control unit 2, in order to reset the same to a lower count value (possibly zero).

In addition, it can be provided that from a specified count value upper limit of at least one of the memories 6 associated to the win symbols 7 resetting to a value greater than zero is effected for this memory, for further or all memories 6, when the loss symbol 10 is represented in the stop position of the display means 3.

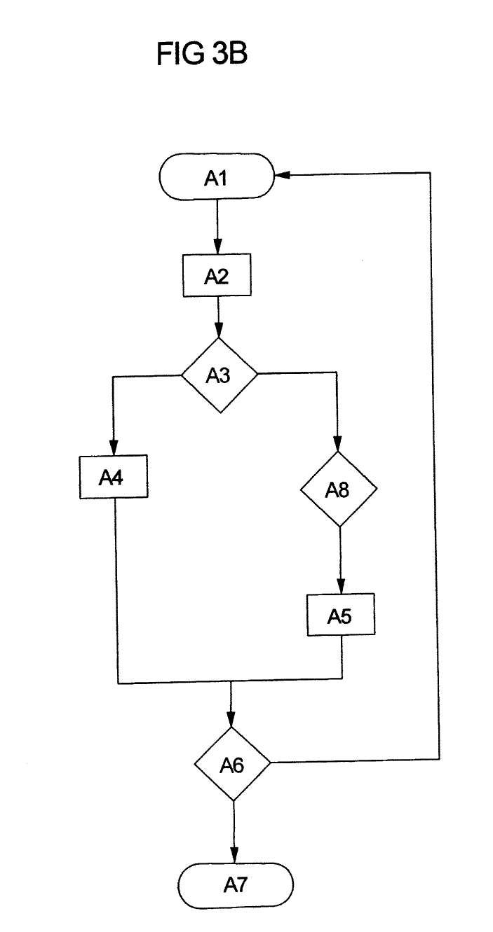

Possible procedures in operation of the gambling or entertainment machine 1A are shown by way of example in the flow diagrams of FIGS. 3A and 3B.

Initially, the start of a game each is effected in a step A1 of FIGS. 3A and 3B by decrementing the required bets from one of the credit memories (point or cash balance) 5.1, 5.2. Subsequently, the stop of the symbol display 3 is effected in a step A2. In a succeeding step A3 it now is checked whether the symbol display 3 indicates a win symbol 7 or the loss symbol 10 in the stop position.

In the case of the representation of a win symbol 7 according to FIG. 2A as game result, the memory 6 associated to the indicated win symbol 7 is incremented by a count value in a succeeding method step A4. Subsequently, a player can decide whether or not the associated win values are to be accepted (step A6 in FIGS. 3A and 3B). Upon acceptance of the win values, the win memory 5.1 or 5.2 is incremented by the sum of the win values. At this point, the player also can decide whether he will terminate the game (step A7). If the player does not want to terminate the game, he can continue the current game—in particular when the player has not accepted the win values achieved so far.

However, if it is noted in step A3 in the flow diagram of FIG. 3A that the symbol display 3 in its stop position indicates the loss symbol 10 according to FIG. 2B, at least one of the memories 6 is reset to zero or—for example if a count value upper limit has been exceeded in a memory 6—to a lower count value greater than zero in a step A5 alternative to the method step A4. Alternatively, all event-dependent memories 6 also can be reset to zero.

In the flow diagram of FIG. 3B an additional step A8 is provided before step A5, when after randomly stopping the symbol display 3 it is noted that the symbol display 3 indicates the loss symbol 10. After representation of the loss symbol 10, a player here can decide which memory 6 should be reset, by actuating the keys 4. For this purpose, the player selects the corresponding win symbol 7 via the keys 4, so that then only the memory 6 associated to this win symbol 7 and hence selected will be reset.

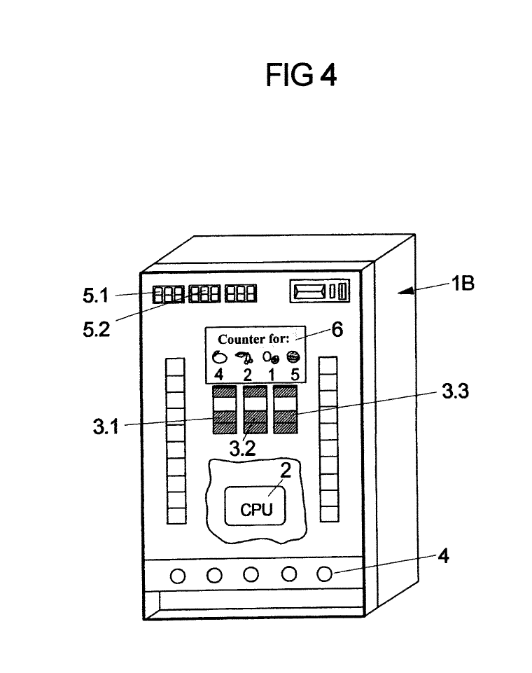

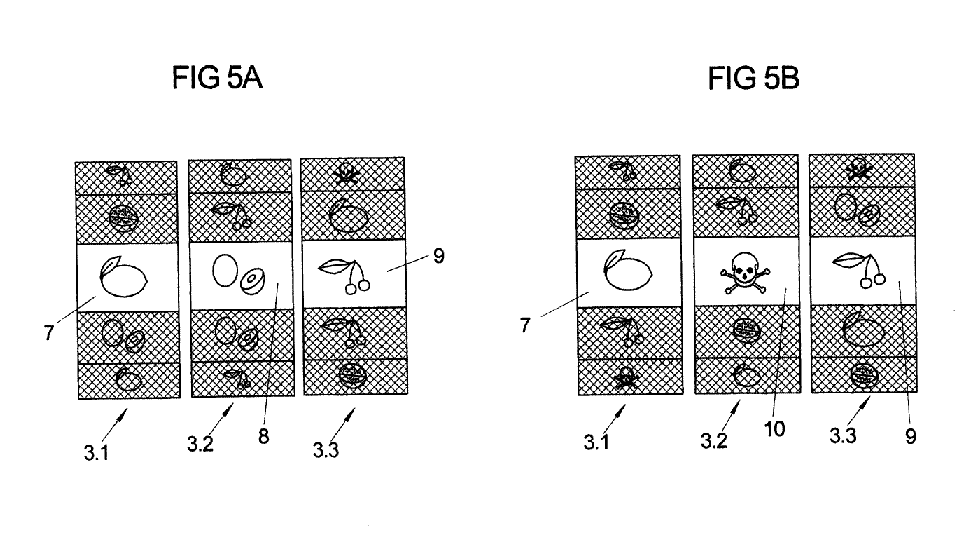

FIG. 4 shows a second automatic gambling or entertainment machine 1B formed according to the invention, which includes a central control unit 2, three random controlled symbol displays 3.1, 3.2 and 3.3 formed as rotating reels for representing game results (shown in part and on an enlarged scale in FIGS. 5A and 5B) as well as keys 4 for influencing the course of the game.

In the method according to the invention, a game also initially is started here by decrementing the required bets of one of the credit memories (point or cash balance) 5.1, 5.2. The display means 3 including symbols are set in motion and subsequently each stopped at a randomly selected position.

In the result of this game, the random controlled display means 3.1, 3.2 and 3.3 show three win symbols 7, 8 and 9 in their windows according to FIG. 5A, which here by way of example consist of a lemon symbol 7, a kiwi symbol 8 and a cherry symbol 9. This game result leads to the fact that the memory 6 associated to the lemon symbol 7, the kiwi symbol 8 and the cherry symbol 9 each is incremented by one count and this is indicated correspondingly.

In a game or win plan not shown in detail, the player is informed which win value is associated to the respectively indicated count value of the individual win symbols 7, 8, 9. For example, the count value “4” for the lemon symbol might symbolize a win value of 80 points, the count value “2” for the cherry symbol and the count value “1” for the kiwi symbol might symbolize a win value of 0 points, and the count value “5” for the melon symbol might symbolize a win value of 250 points.

By actuating one of the keys 4 for influencing the course of the game, the player might accept the associated win values, whereby the associated win memory 5.1 or 5.2 is incremented by the sum of the win values. At the same time, the memories 6 associated to the win symbols 7, 8, 9 would be reset.

When the game is continued without accepting this win, it is possible that as next game result the loss symbol 10 also is displayed in the windows of the display means 3.1, 3.2 and 3.3, when the same are randomly stopped. In this case—like in the first exemplary embodiment of FIGS. 1, 2A and 2B explained above with only one symbol display 3—it can be provided that for example all count values of the win symbols 7, 8, 9 stored in the event-dependent memory 6 and indicated are reset to zero. Thus, this would correspond to a total loss of the win values achieved so far.

Alternatively, it can be provided for example that only the greatest count value stored and indicated—i.e. in the illustrated case the count value “5” for the melon symbol—is reset to zero or a lower count value. In this case, the appearance of the loss symbol 10 would not mean a total loss of win values achieved so far, but only a partial loss.

Furthermore, it is possible that upon appearance of the loss symbol 10 at least one of the memories 6 for the win values of the win symbols counted so far is randomly selected via the central control unit 2, in order to reset the same to a lower count value (possibly zero).

In addition, it can be provided that from a specified count value upper limit of at least one of the memories 6 associated to the win symbols 7, 8, 9 resetting to a value greater than zero is effected for this memory, for further or all memories 6, when the loss symbol 10 is represented in the stop position of the display means 3.1, 3.2 and 3.3.

Due to the method according to the invention, the player himself can decide whether he wants to accept the achieved win values as game result, which he can initiate by corresponding key actuation of one of the keys 4 for influencing the course of the game, or whether he wants to play on with the aim of increasing the win value. In doing so, however, he risks to lose everything or a part of the win values achieved so far via the loss symbol 10.

1. A method for controlling a gambling or entertainment machine, which includes at least one central control unit, at least one display means including symbols, in particular a reel or a disk or a screen, keys actuatable by the player to influence the course of the game, memories with associated displays for credits and/or winnings as well as event-dependent memories, wherein
actuating, by the central control unit, the at least one display means to stop at random positions, the at least one display means including various win symbols and at least one loss symbol,
counting a win symbol, indicated in the stop position of the at least one display means including symbols, in a memory associated to the win symbol, wherein win values are associated to a respective count value, and
resetting, when the loss symbol is represented in the stop position of the at least one display means, at least one of the memories associated to the win symbols.

2. The method for controlling a gambling or entertainment machine according to claim 1, wherein when the loss symbol is represented in the stop position of the at least one display means, all memories associated to the win symbols are reset.

3. The method for controlling a gambling or entertainment machine according to claim 1, wherein when the loss symbol is represented in the stop position of the at least one display means, several memories are reset, wherein each reset memory is associated to another one of the win symbols.

4. The method for controlling a gambling or entertainment machine according to claim 1, wherein when the loss symbol is represented in the stop position of the at least one display means, the memory with the largest count value associated to the win symbols is reset.

5. A method for controlling a gambling or entertainment machine according to claim 1, wherein when the loss symbol is represented in the stop position of the at least one display means, at least one memory associated to the win symbols is randomly selected and reset via the central control unit.

6. The method for controlling a gambling or entertainment machine according to claim 1, wherein when the loss symbol is represented in the stop position of the at least one display means, a memory associated to the win symbols is selected in a player-controlled manner via the keys actuatable by the player to influence the course of the game and then reset.

7. The method for controlling a gambling or entertainment machine according to claim 1, wherein from a specified count value upper limit of at least one of the memories associated to the win symbols, when the loss symbol is represented in the stop position of the at least one display means, resetting of this or another memory is effected to a value greater than zero.

8. The method for controlling a gambling or entertainment machine according to claim 1, wherein only one display means including symbols is provided with various win symbols and at least one loss symbol which display means is actuated by the central control unit and stopped at random positions.

9. The method for controlling a gambling or entertainment machine according to claim 1, wherein at least two display means each including symbols are provided with various win symbols and at least one loss symbol which display means are actuated by the central control unit and stopped at random positions.

10. A gambling or entertainment machine, which includes at least one central control unit, at least one display means including symbols, in particular a reel or a disk or a screen, keys actuatable by the player to influence the course of the game, memories with associated displays for credits and/or winnings as well as event-dependent memories, wherein
the at least one display means including the symbols includes various win symbols and at least one loss symbol, and
the central control unit is formed and provided to
actuate the at least one display means and stop the same at random positions,
count win symbols indicated in the stop position of the at least one display means each in a memory associated to the win symbol, wherein win values are associated to the respective count value, and
when the loss symbol is represented in the stop position of the at least one display means, reset at least one of the memories associated to the win symbols.
